(19) United States
(12) Patent Application Publication
(10) Pub. No.: US 2026/0138895 A1
(43) Pub. Date: May 21, 2026

(54) CATALYZED ULTRAVIOLET LIGHT PFAS DESTRUCTION

(71) Applicant: Parsons Corporation, Centreville, VA (US)

(72) Inventors: Natalia O’Connor, Centreville, VA (US); David Patch, Centreville, VA (US); Daniel R. Griffiths, Denver, CO (US)

(21) Appl. No.: 19/393,548

(22) Filed: Nov. 18, 2025

Related U.S. Application Data
(60) Provisional application No. 63/722,572, filed on Nov. 19, 2024.

(51) Int. Cl. C02F 1/32; C02F 101/36

(52) U.S. Cl. CPC C02F 1/325; C02F 2101/36; C02F 2201/322; C02F 2209/003

(57) ABSTRACT

A system for continuous PFAS destruction is disclosed containing a multi-quartz tube assembly arranged around a UV lamp and having geometries designed for energy efficient destruction of PFAS.

### CROSS-REFERENCE TO RELATED APPLICATIONS

This application claims priority to U.S. Provisional Application Ser. No. 63/722,572 filed Nov. 19, 2024, the entire contents of which are incorporated herein by reference.

### TECHNICAL FIELD

Embodiments of the present invention relate, in general, to PFAS remediation and more particularly to the continuous destruction of PFAS using Ultraviolet Light

### BACKGROUND

Per- and polyfluoroalkyl substances (PFAS) are a large class of synthetic anthropomorphic organofluorine compounds that are ubiquitous, recalcitrant, and linked to a growing number of toxicological effects. PFOS, PFOA, and PFBS are some of the species of the genus PFAS. Characterized by their high proportion of carbon fluorine bonds, they all share a common perfluoroalkyl moiety (e.g. CnFx, where x=1-3). The carbon fluorine bond, characterized by the highest bond dissociation energy in organic chemistry and due to this, traditional methods of treating water contaminants falter when used to treat PFAS impacted matrices.

A report by the Centers for Disease Control and Prevention that used data from the National Health and Nutrition Examination Survey (NHANES) estimates that 97% of Americans have detectable concentrations of PFAS in their blood. Drinking water and diet has been established as the main route of exposure, and to a lesser extent inhalation of indoor air.

PFAS can migrate from consumer products into our bodies directly, or from unlined landfills into the ground where they can reach the water table. PFAS are a component of class B aqueous film-forming foams (AFFFs) and are discharged into the environment, representing a major source of direct environmental release. Environmentally relevant concentrations in groundwater range from 0.01 ng/L to ˜5 mg/L for PFOS and <0.03 ng/L to ˜7 mg/L for PFOA, two of the most reported PFAS.

Current methods for PFAS removal typically involve adsorption to different matrices such as granular activated carbon, which is readily available and easy to implement, or ion exchange resins, however these methods do not destroy or eliminate the PFAS, they simply move the contamination around to be sequestered or incinerated. Destruction methods like incineration can be initially cost-prohibitive and can generate PFAS transformation products, which are usually just as recalcitrant as their parent molecules and potentially equally as toxic. Moreover, incineration produces unwanted byproducts such as hydrogen fluoride (HF), which is the main byproduct, a corrosive, and toxic gas. Among the various PFAS treatment technologies, the most successful methods are those that enable a reductive aqueous environment. Notably, the utilization of ultraviolet (UV) light to activate reductive photosensitizers has emerged and has been proven as a promising approach.

UV-light activated iodide with sulfite in an alkaline environment produces a strong reductive environment due to the generation of hydrated electrons (Eaq=−2.9V). Hydrated electrons possess a strong enough reductive potential to break the recalcitrant bonds found in PFAS. This technology has shown to achieve near-complete (>99%) destruction of PFBS in 8 hours, PFOS in 30 minutes, and PFOA in 15 minutes using batch-style reactors in either UV-transmissible cuvettes or beakers.

While viable as a form of treatment in the limited environment of a laboratory, a batch approach of PFAS treatment is not scalable. What is needed is a flow-through treatment system designed for continuous destruction of PFAS. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY

In one embodiment, a system for continuous PFAS destruction is described, comprising: a multi-quartz tube assembly configured for arranging around a UV lamp; a reagent introduction mechanism for delivering a photosensitizer mixture into the multi-quartz tube assembly; and a flow control mechanism for regulating the flow of an aqueous PFAS-containing solution through the multi-quartz tube assembly.

In another aspect, a method for PFAS destruction is described, comprising: mixing a PFAS-containing solution with a photosensitizer mixture; irradiating the mixture with ultraviolet light in a tubular system; and continuously flowing the mixture through the system to achieve PFAS destruction.

In yet another embodiment, a UV-activated chemical treatment apparatus, comprising: a housing for containing a UV light source; a circulation system for aqueous solutions; and a reagent delivery system for introducing sulfite-based photosensitizers.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings and figures.

The Figures depict embodiments of the present invention for purposes of illustration only. One skilled in the art will readily recognize from the following discussion that alternative embodiments of the structures and methods illustrated herein may be employed without departing from the principles of the invention described herein.

FIG. 1 is an illustration of one embodiment of the full scale “Tubulator” reactor system, detailing a multi-quartz tube system positioned around a UV lamp, with probes, vents, sampling ports, and reagent introduction ports detailed.

FIG. 2A is a graph determining the free (inorganic) fluoride concentration increasing as a result of PFOS destruction in stock solution 1.

FIG. 2B is a graph determining the free (inorganic) fluoride concentration increasing as a result of PFOS destruction in stock solution 2.

FIG. 3A is a graph showing the concentration of free (inorganic) fluoride generated over time during PFAS destruction of PFOS stock solution 1 in the 25 mm ID, 30 mm distanced quartz reactor.

FIG. 3B is a graph showing the relative organic fluorine destruction (Equation 2) in PFOS stock solution 1 over time.

FIG. 3C is a graph showing the first order rate law determination (k=1.398 h⁻¹. Equation 1) for destruction of PFAS in PFOS stock solution 1 over time.

FIG. 3D shows an illustrative representation of the reactor used to perform the reactions shown in FIGS. 3A, 3B, and 3C, where the 19 mm OD UV Lamp is positioned 30 mm from two 25 mm Quartz Tubes and used to destroy the PFAS in PFOS stock solution 1.

FIG. 4A is a graph showing the concentration of free (inorganic) fluoride generated over time during PFAS destruction of PFOS stock solution 1 in the 25 mm ID, 40 mm distanced quartz reactor.

FIG. 4B is a graph showing the relative organic fluorine destruction (Equation 2) in PFOS stock solution 1 over time.

FIG. 4C is a graph showing the first order rate law determination (k=0.972 h⁻¹, Equation 1) for destruction of PFAS in PFOS stock solution 1 over time.

FIG. 4D shows an illustrative representation of the reactor used to perform the reactions shown in FIGS. 4A, 4B, and 4C, where the 19 mm OD UV Lamp is positioned 40 mm from two 25 mm Quartz Tubes and used to destroy the PFAS in PFOS stock solution 1.

FIG. 5A is a graph showing the concentration of free (inorganic) fluoride generated over time during PFAS destruction of PFOS stock solution 1 in the 25 mm ID, 50 mm distanced quartz reactor.

FIG. 5B is a graph showing the relative organic fluorine destruction (Equation 2) in PFOS stock solution 2 over time.

FIG. 5C is a graph showing the first order rate law determination (k=0.748 h⁻¹, Equation 1) for destruction of PFAS in PFOS stock solution 2 over time.

FIG. 5D shows an illustrative representation of the reactor used to perform the reactions shown in FIGS. 5A, 5B, and 5C, where the 19 mm OD UV Lamp is positioned 50 mm from two 25 mm Quartz Tubes and used to destroy the PFAS in PFOS stock solution 2.

FIG. 6A is a graph showing the concentration of free (inorganic) fluoride generated over time during PFAS destruction of PFOS stock solution 2 in the 30 mm ID, 30 mm distanced quartz reactor.

FIG. 6B is a graph showing the relative organic fluorine destruction (Equation 2) in PFOS stock solution 2 over time.

FIG. 6C is a graph showing the first order rate law determination (k=0.768 h⁻¹, Equation 1) for destruction of PFAS in PFOS stock solution 2 over time.

FIG. 6D shows an illustrative representation of the reactor used to perform the reactions shown in FIGS. 6A, 6B, and 6C, where the 19 mm OD UV Lamp is positioned 30 mm from two 30 mm Quartz Tubes and used to destroy the PFAS in PFOS stock solution 2.

FIG. 7A is a graph showing the concentration of free (inorganic) fluoride generated over time during PFAS destruction of PFOS stock solution 2 in the 34 mm ID, 30 mm distanced quartz reactor.

FIG. 7B is a graph showing the organic fluorine destruction (Equation 2) in PFOS stock solution 2 over time.

FIG. 7C is a graph showing the first order rate law determination (k=0.422 h⁻¹, Equation 1) for destruction of PFAS in PFOS stock solution 2 over time.

FIG. 7D shows an illustrative representation of the reactor used to perform the reactions shown in FIGS. 7A, 7B, and 7C, where the 19 mm OD UV Lamp is positioned 30 mm from two 34 mm Quartz Tubes and used to destroy the PFAS in PFOS stock solution 2.

FIG. 8A is a graph showing the concentration of free (inorganic) fluoride generated over time during PFAS destruction of PFOS stock solution 2 in the 10 mm ID, 12 mm distanced quartz reactor.

FIG. 8B is a graph showing the relative organic fluorine destruction (Equation 2) in PFOS stock solution 2 over time.

FIG. 8C is a graph showing the first order rate law determination (k=2.486 h⁻¹, Equation 1) for destruction of PFAS in PFOS stock solution 2 over time.

FIG. 8D shows an illustrative representation of the reactor used to perform the reactions shown in FIGS. 8A, 8B, and 8C, where the 19 mm OD UV Lamp is positioned 12 mm from two 10 mm Quartz Tubes and used to destroy the PFAS in PFOS stock solution 2.

FIG. 9A is a side view of one embodiment of the reactor of the present disclosure.

FIG. 9B is a top perspective view of the embodiment of the reactor shown in FIG. 9A.

FIG. 9C is an end view of one embodiment of the reactor shown in FIG. 9A.

FIG. 10 is a perspective view of the U-bend element 200 from FIG. 9A

FIG. 11 is a front view of an alternative embodiment of the U-bend element in FIG. 10.

FIG. 12 is a front view of an alternative embodiment of the U-bend element in FIG. 10.

FIG. 13 is a top perspective of a baseplate coupled to a plurality of U-bend elements, which may be employed in one or more embodiments of the present disclosure.

FIG. 14 is a top perspective of a guide collar, optionally coupled to the plurality of quartz tubes (not shown) in one or more embodiments of the present disclosure.

FIG. 15 is a photograph of one embodiments of the reactor of the present disclosure.

FIG. 16A is a photograph of the reactor of FIG. 15 coupled to a power source for pumping a PFAS containing solution and powering the central UV light source.

FIG. 16 B is a photograph of the reactor of FIG. 16A with the power source turned on and external lights turned off.

FIG. 17 is a graph comparing the measured free fluoride (squares) over time using an embodiment of the reactor having 10 mm quartz tubes and a UV lamp spaced 15 mm distance from each tube to a theoretical model of free fluoride (dashed line) to be produced.

FIG. 18 is an illustrative image of ideal and non-ideal flow rate of the reaction mixture through the reactor system.

FIG. 19 is a graph showing the measured free fluoride (squares) over time use an the reactor of FIG. 17 with larger inner diameter pump tubing and a pump rate of 15 mL/min as compared to the expected (dash lines) of free fluoride to be produced.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

Continuous PFAS destruction is accomplished using a series of quartz tubes positioned in series around a UV lamp. One or more embodiments of the present invention (referred to herein as the ‘Tubulator’ or “reactor”) addresses the pressing issue of per- and polyfluoroalkyl substances (PFAS) in water. PFAS are an anthropogenic class of emerging contaminants that have been associated with several negative health effects, including cancer. The USEPA has recently regulated several PFAS, including PFOS and PFOA, at a maximum contaminant level (MCL) concentration of 4 ng/L. The present invention solves this problem by creating a synergistic reactive system in water capable of destroying PFAS (>99.9%) in a short period of time (<1 hour, PFOS) and in a continuous flow through system. In one embodiment of the present invention reactor parameters include quartz tube inner diameter of about 10 mm, 25 mm, 30 mm, or 34 mm; a distance from a UV lamp of about 12 mm, 15 mm, 30 mm, 40 mm, or 50 mm; U-bend design; and controlled flow rates achieved PFAS destruction at an approximate rate of 1 L/hour.

To date, the only effective water treatment technology is the use of adsorptive materials, like granular activated carbon or ion exchange resins, to remove PFAS from the water. However, this prior art process only transfers the PFAS from one system (water) to another (the adsorptive material), which generates a secondary waste stream that still requires disposal. The present invention converts PFAS to inorganic fluoride and other innocuous waste products, which can be easily neutralized, recycled, or otherwise captured.

One or more embodiments of the present invention achieves complete or near-complete mineralization of PFAS in aqueous systems in under one hour. The mineralization (also referred to herein as “destruction”) of PFOS, and other PFAS, is achieved through the interaction of PFAS with aqueous electrons and other reactive radical species. These reactive radical species are generated through ultraviolet light activated photosensitizing chemicals, including sulfite (sodium, potassium), iodide (sodium, potassium), and (bi) carbonate (sodium, potassium), under alkaline conditions which is achieved using hydroxide (sodium, potassium). Compared to previous works, which have utilized UV-activated processes to destroy PFAS in a batch reactor, this work achieves PFAS destruction in a continuous flow through operation. The continuous flow-through operation allows for high treatment volumes and the continuous monitoring and modification of key water chemistry parameters, including temperature, pH, dissolved oxygen, fluoride, and reagent concentration. The reactor design of the present invention is modular, allowing for optimized treatment of PFAS-impacted waters under a variety of scenarios. Lastly, this invention is designed to allow for incorporation into treatment train systems with different types of pre-treatment systems (e.g. oxidative pre-treatment, foam fractionation, sedimentation) and post-treatment systems (e.g. oxidative post-treatment, pH adjustment, fluoride removal, sorption-based cleanup). The internal oxidative-reductive potential (ORP) of the system can also be fine-tuned through the addition of sulfite (reductive), or dissolved oxygen using an air sparger (oxidative). All of the aforementioned technical designs of this system result in a novel approach capable of destroying PFAS in a variety of aqueous matrices.

The present invention allows for more heterogenous reaction conditions and reaction chemistry within the system to foster complete or near-complete PFAS destruction. This heterogeneous reaction chemistry promotes degradation of both the parent PFAS compounds, as well as any partially degraded PFAS transformation products, which can be more recalcitrant than their parent molecules. The invention allows for complete irradiation of the PFAS solution volume and more efficient generation of aqueous electrons. While batch systems known to the prior art are limited in ability to irradiate the entirety of the PFAS solution, the present invention's flow through design provides complete irradiation resulting in complete or near-complete PFAS destruction. Moreover, the system can include monitoring of ongoing chemical reactions present in the system environment and in doing so can adjust the chemical composition to enhance the efficacy of PFAS destruction.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be employed by those skilled in the art without departing from the spirit and scope of the invention.

This work is distinguished from previous work based on its novel operation method (flow-through design), the ability to perform UV-activation of chemicals without needing to immerse the UV lamp into a quartz jacket or housing, and destruction of PFAS to sub-parts-per-billion concentrations. This invention also utilizes an air diffusion system (e.g. air sparger) to finely tune the radical chemistry within the system, allowing for the generation of oxidative or reductive radicals which are required at different stages of treatment to achieve complete PFAS destruction.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein the term “ID” refers to inner diameter of the quartz tube.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the Figures. It will be understood that the spatially relative terms are intended to encompass different orientations of a device in use or operation in addition to the orientation depicted in the Figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Unless stated otherwise, the “distance” between the one or more quartz tubes and the UV lamp is measured from the surface of the lamp to the surface of the quartz tube.

The present invention employs photochemical processes to achieve the destruction of PFAS in aqueous matrices. Unless otherwise indicated, destruction of PFAS means a destruction of at least about 90%, at least about 90.5%, at least about 91%, at least about 91.5%, at least about 92%, at least about 92.5%, at least about 93%, at least about 93.5%, at least about 94%, at least about 94.5%, at least about 95%, at least about 95.5%, at least about 96%, at least about 96.5%, at least about 97%, at least about 97.5%, at least about 98%, at least about 98.5%, at least about 99%, at least about 99.5%, at least about 99.7%, or at least about 99.9% of PFAS in a sample. The term “complete destruction,” refers to the destruction of at least about 99%, at least about 99.5%, at least about 99.7%, or at least about 99.9% of PFAS in a sample, or a reduction of the PFAS to a concentration that can not be readily detected by currently available analytical methodology, such that the PFAS are considered ‘non-detectable’. Under this scenario in which PFAS concentrations post-treatment are considered ‘non-detectable’, the percent reduction of PFAS is based on the detection limit of the analytical method and the initial concentration of PFAS before treatment is applied.

Unless otherwise stated, the UV/sulfite+iodide photochemical system used in this study consists of a sulfite salt (e.g. sodium, potassium) (20 mM SO₃²⁻, range of 10-50 mM), an iodide salt (e.g. sodium, potassium) (10 mM I⁻, range 0.1-20 mM), a bicarbonate or carbonate salt (e.g. sodium, potassium, hydrogen) (10 mM HCO₃⁻, or CO₃²⁻, range 0.1-100 mM), and a hydroxide salt (e.g. sodium, potassium, calcium) (150 mM, range 50-200 mM). The cations described above (e.g. sodium, potassium, hydrogen, calcium) are spectator ions and interchangeable and could be any alkali, alkali earth metal, transition metal, or organic molecule. The concentrations described above are the final (target) concentrations to be reached within the PFAS-impacted aqueous matrix to be treated.

After sufficient mixing the PFAS-impacted waste stream is irradiated with UV light (range of UV light 185-254 nm). In one embodiment a UV wavelength of 254 nm is used while in another version of the present invention a dual 254/185 nm irradiation source is selected. Variances in the wavelength along the PFAS path is also an aspect of the present invention. This process generates aqueous electrons and other key radicals, creating a highly reducing environment capable of initiating PFAS destruction. The aqueous environment is, in one embodiment of the preset invention, subsequently modified through continued irradiation and the introduction of additional reagents to prioritize the most appropriate radicals to continue PFAS destruction.

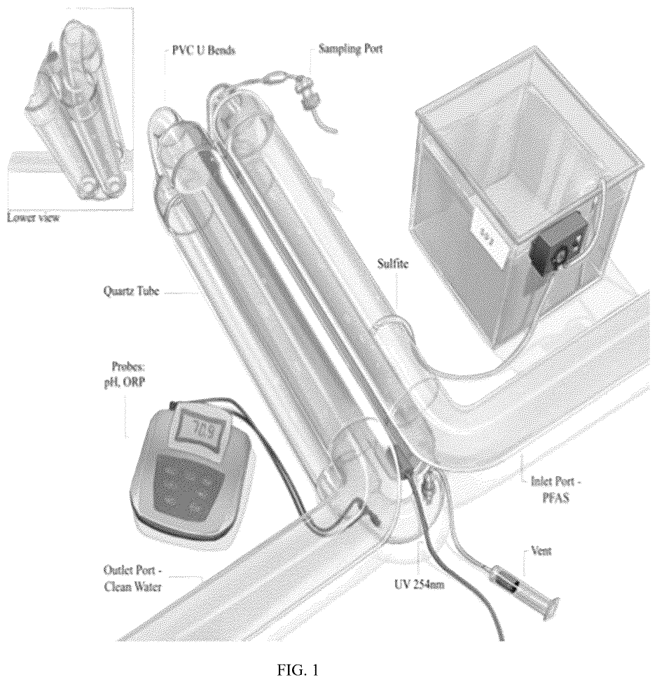

The system development and optimization of the present invention are performed across three phases: initial PFAS solution characterization, system geometry/volume investigation, and initial prototype development/investigation. Each phase uses the above photochemical reactions described, albeit in different reagent concentrations, addition timings, or irradiation times/strengths. One embodiment of the presented reactor, referred to internally as the ‘Tubulator’, can be seen FIG. 1.

As shown in the illustrated reactor of FIG. 1, the reactor system includes a plurality of quartz tubes, referred to as a “multi-quartz tube system” positioned around a UV lamp, with probes, vents, sampling ports, and reagent introduction ports identified.

The following exemplary embodiments and Examples are provided to show the evolution and proof of concepts that ultimately lead to the final reactor system including the device and methods of use. While specific embodiments are described, modifications in keeping with the scope and functionality of the present reactor are also encompassed in the present disclosure.

The reactor system of the present disclosure will be described as a phase-based approach. Phase one focuses on using the UV/sulfite+iodide system in UV transmissible cuvettes to achieve complete defluorination of PFAS. This scalable, analytical-focused method allows for the determination of the total organic fluorine present within a sample, which forms the basis for evaluating the effectiveness of PFAS destruction.

Phase two is focused on using the UV/sulfite+iodide system in larger scale volumes (50-2000 mL) under different arrangements of systems (recirculating treatment in quartz tubes) to determine the optimization of parameters for designing the flow-through treatment system. These parameters include quartz tube inner diameter, quartz tube distance from the lamp, and lamp strength (wattage).

The third phase is directed to evaluating the UV/sulfite+iodide system in a fully designed ‘Tubulator’ system, complete with quartz tubes, U-bends, and a continuous flow through system. Due to the variety of different volumes and systems used throughout this phase a sample nomenclature system was set in place to ensure organization of samples and data. All samples are labelled with 3 alphanumeric characters. The first character is a letter to indicate which system was used for experiments, C—cuvette, T—recirculating quartz tube, Q—Static batch system in quartz tube, and P—pilot benchtop flow-through. The second character(s) is a number corresponding to the samples identifier and order within an experimental batch. The third character is a letter to differentiate experimental batches within a system, A—1st batch of experiments, B—2nd batch of experiments and so on. For example: C1A—sample 1 in the first batch of experiments in the cuvette system.

Analytical methods were employed to avoid the expense and long turn-around-times associated with commercial analysis. Verifiable success was evaluated using in-house inorganic fluoride measurements (using a fluoride ion selective electrode, as described by EPA Method 9214). The inorganic fluoride measurements were compared to the expected inorganic fluoride concentrations, based on the concentration of organic fluorine initially present within the system. Commercial PFAS analysis (EPA 1633) was used for the characterization of initial PFAS stock solutions, and evaluation of the first version of the final prototype. This was done to improve confidence in subsequent inorganic fluoride determinations, and to identify key areas for additional embodiments of the invention.

Development of the flow-through UV-activated treatment system of the present invention used a large foundation of experimental data to identify the key variables within the system, and the range across variables at which PFAS destruction was most effective. To this end, analysis performed were achieved across several stages: initial organic fluorine stock concentrations (1), PFAS destruction as a function of reactor distance from the lamp (2), PFAS destruction as a function of reactor inner diameter (3), reactor geometry evaluation (4), and PFAS destruction in a fully engineered system (5).

The sections below report and discuss the data collected during this analysis, with reference (where possible) to the specific data tables. Typical PFAS remediation investigations focus on the determination of PFAS concentrations with respect to increasing treatment (determined using liquid chromatography mass spectrometry, or LC-MS), and subsequent measurement of the free fluoride generated because of PFAS destruction (determined using fluoride-ion selective electrode, or F-ISE). In scenarios where the loss of PFAS is higher than the gain of fluoride, this is referred to as PFAS degradation. In scenarios where the loss of PFAS is equal to the gain of fluoride, this is referred to as PFAS destruction, which is the goal of any destructive PFAS treatment technology. Due to the prohibitive cost of LC-MS analysis, initial analysis in this work were evaluated for success by measuring free fluoride, and comparing the amount of free fluoride generated to the total amount of organic fluorine expected.

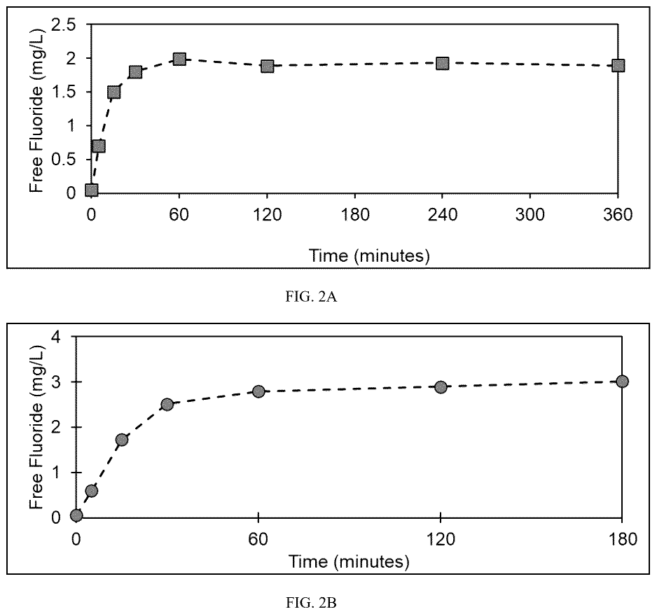

To this end, the first versions of the present invention were focused on evaluating the concentration of organic fluorine present in two PFOS stock solutions using non-LC-MS published methods. Organic fluorine concentrations of both stock solutions were determined by destroying the PFAS using UV-transmissible cuvette reactors (FIG. 2A and FIG. 2B).

As shown in FIG. 2A, concentrations of free organic fluoride was determined in a PFOS stock solution 1. FIG. 2B shows the measured concentration of free organic fluoride in PFOS stock solution 2.

Results from the reductive defluorination of PFOS identified total organic fluorine concentrations of 1.9 mg/L (PFOS stock solution 1), and 3.0 mg/L (PFOS stock solution 2). These two organic fluoride concentrations were used to evaluate overall PFAS destruction in subsequent investigations, including the determination of effective reactor distances and diameters.

Following the determination of the organic fluorine concentrations in the PFOS stock solutions 1 and 2, investigations focused on identifying the effective distance from the quartz tubing to the UV lamp. Without being limited by theory, it was hypothesized that as distance increased, PFAS destruction would decrease (due to the reduced UV irradiance per unit surface area), but the possible treatment volume would increase (due to increase in total UV irradiated surface area). Therefore, each reactor configuration was evaluated for total PFAS destruction, the rate of PFAS destruction, and the electrical consumption per order of magnitude PFAS destroyed (E_{Eo}). The calculation of the E_{Eo} of the system allows for a comparison of PFAS destruction across different reactor geometries as it normalizes for treatment volume. The E_{Eo} of a system can be calculated from the following equation (Equation 1):

$${E}_{E O} = - ln ( \frac{C}{C o} ) * \frac{P}{k V} \qquad ( Equation 1 )$$

where:
C=concentration of PFAS at time X (mg/L)
C_{O}=concentration of PFAS in the initial system (mg/L)
P=power of the lamp (kW)
k=the first order rate constant of PFAS destruction (h⁻¹)
V=the volume of the water (m³).

In this analysis, the extent of PFAS destruction itself is determined mathematically by dividing the concentration of free (inorganic) fluoride measured at time X by the total organic fluorine concentration present in the system before treatment. Therefore, more accurately, the equation in this work can be shown as follows (Equation 2):

$$Organic Fluorine C / Co = ( \frac{C o - {C}_{F}}{C o} ) * 1 \; 00 \% \qquad ( Equation 2 )$$

where:
C_{F}=Concentration of free fluoride at time X generated by the destruction of PFAS (mg/L)
C_{O}=Concentration of theoretical maximum organic fluoride in the initial system (mg/L)
Organic Fluorine C/C_{O}=The concentration of organic fluorine (PFAS) present in the system at a given time

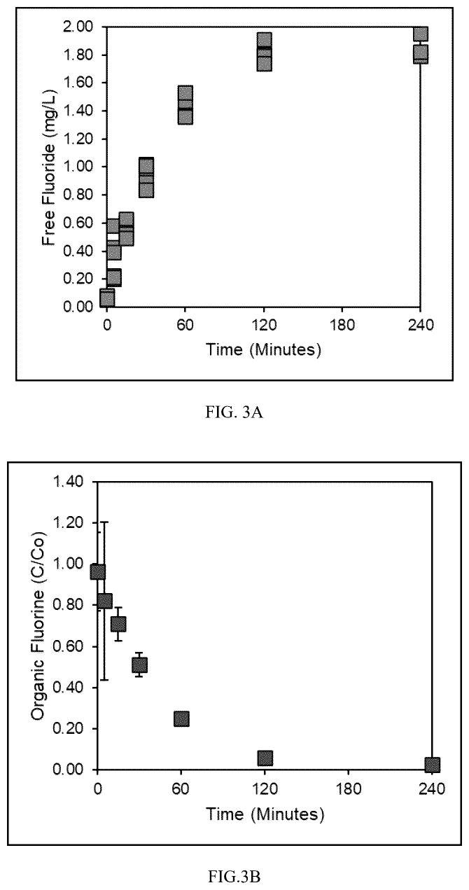

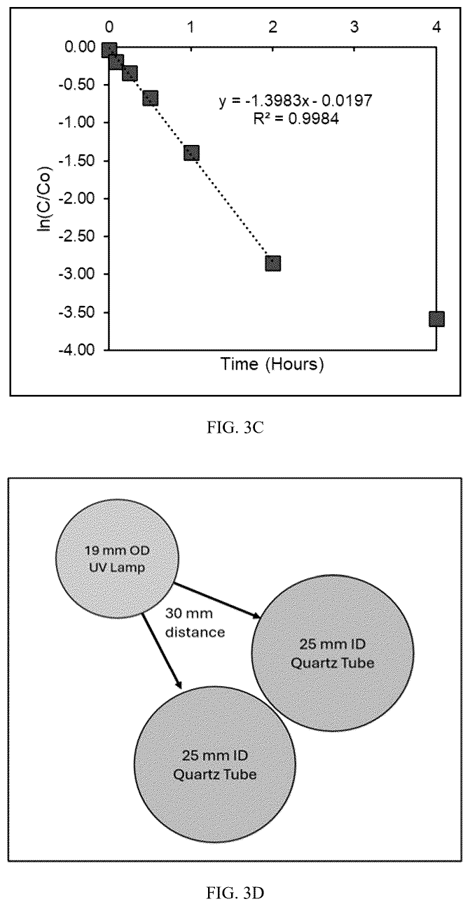

With the above formula having been defined, the overall effectiveness of each reactor can be evaluated. Using two 25 mm inner diameter quartz tubes connected by a PVC U-Bend, at a distance of 30 mm away from the UV lamp, the destruction of PFAS was accomplished using a PFOS solution 1 (1.90 mg/L organic fluoride) over a four-hour period. The results of this study are shown in FIGS. 3A, 3B, and 3C, with FIG. 3D providing an illustrative depiction of the geographic orientation of the quartz tubing and UV lamp.

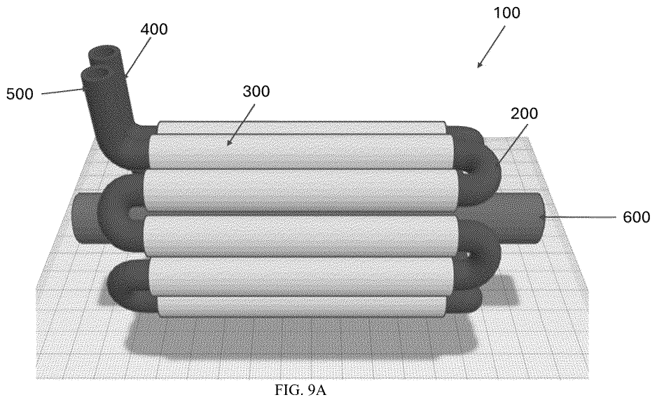

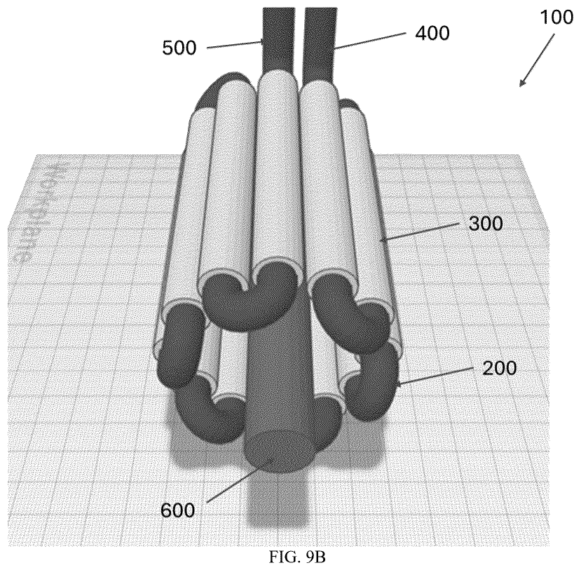

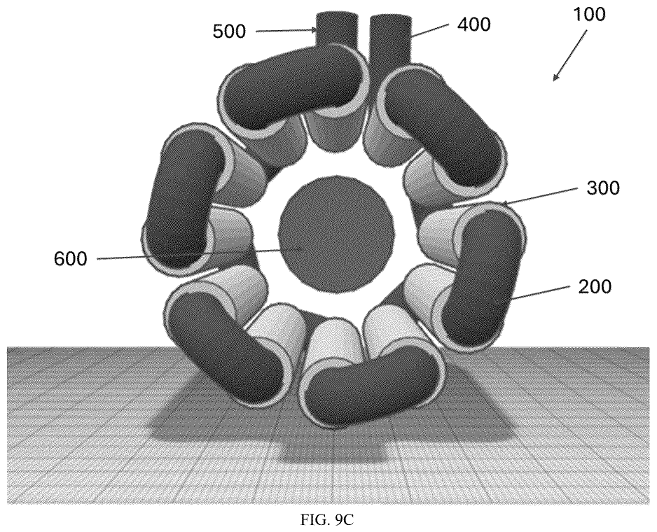

In this first reactor configuration (30 mm distance from UV lamp, 25 mm inner diameter (“ID”) reactor as shown in FIG. 3D), >90% PFOS destruction was achieved by two hours (see FIGS. 3A and 3B), with a first order rate of about 1.40 hr⁻¹ (see FIG. 3C). Considering a per-tube volume of 0.226 L, a quartz tube outer diameter of 28 mm, and a theoretical irradiance circumference of 333 mm, the theoretical system volume was calculated to be 3.7 L (factoring in U-bend volumes described further below and in FIGS. 9A, 9B, 9C, 10, 11, and 12). This equates to a theoretical treatment volume of 1.85 L/hour, and an E_{Eo} of 29 kWh/m³.

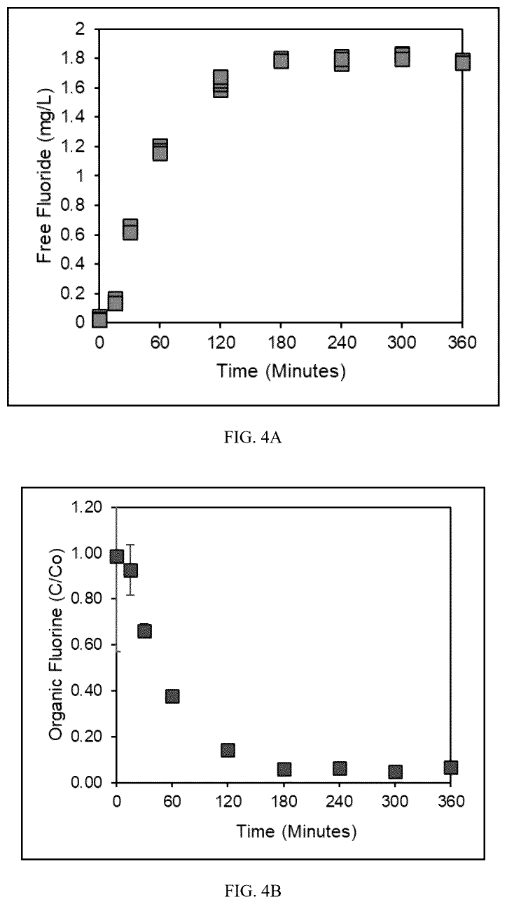

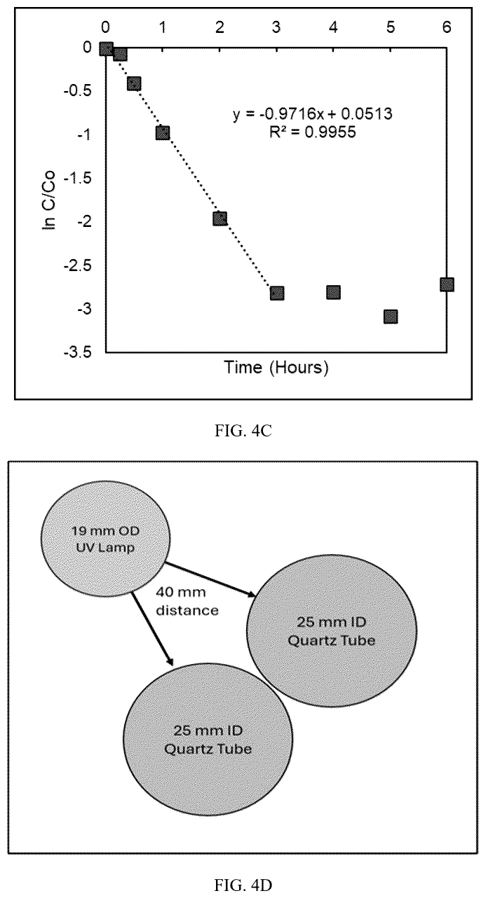

In a second embodiment, two 25 mm inner diameter quartz tubes connected by a PVC U-Bend, at a distance of 40 mm away from the UV lamp, the destruction of PFAS was evaluated using PFOS solution 1 (1.90 mg/L organic fluoride) over a six-hour period, as shown in FIGS. 4A, 4B, 4C, and 4D. In this second reactor configuration (40 mm distance from lamp, 25 mm ID reactor as shown in FIG. 4D), >90% PFOS destruction was achieved by 2.5 hours (see FIGS. 4A and 4B), with a first order rate of about 0.97 hr⁻¹ as shown in FIG. 4C. The slower treatment rate is expected due to the reduced UV irradiance over the surface area of the quartz tubes. Considering the larger theoretical irradiance circumference of 393 mm, this results in a theoretical system volume of 4.5 L, and an E_{Eo} of 35 kWh/m³. The difference of E_{Eo} between the 30 mm and 40 mm system indicates that despite the larger treatment volume at the 40 mm distance, the increased treatment rate of the 30 mm distance is enough to offset the loss of volume. This system has a theoretical treatment rate of 1.81 L/hour.

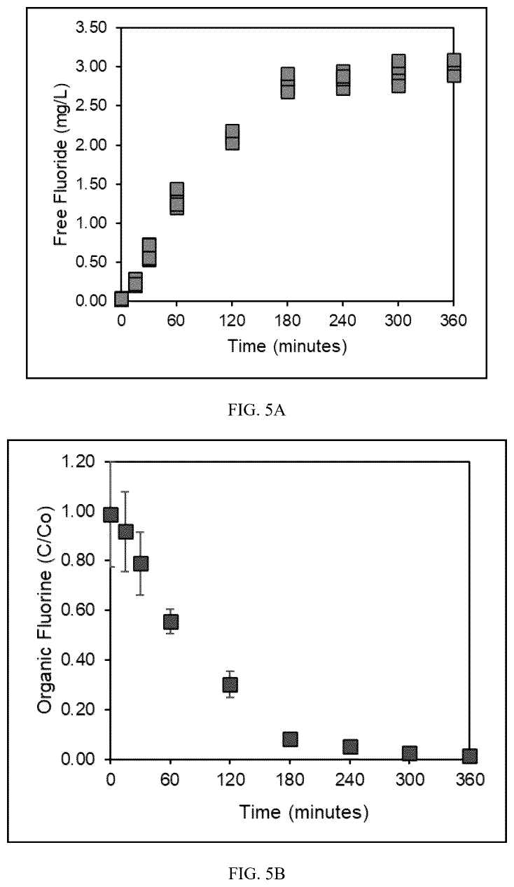

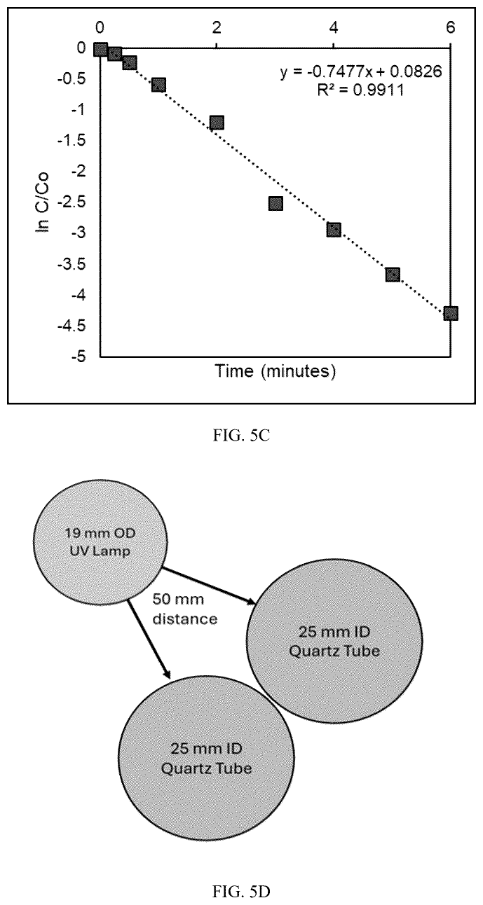

In a third embodiment, two 25 mm diameter quartz tubes connected by a PVC U-Bend, at a distance of 50 mm away from the UV lamp, the destruction of PFAS was evaluated using PFOS stock solution 2 (3.00 mg/L organic fluoride) over a six-hour period. The results of this study are shown in FIGS. 5A, 5B, and 5C, with FIG. 5D providing an illustrative depiction of the geographic orientation of the quartz tubing and UV lamp.

In this third reactor configuration (50 mm distance from lamp, 25 mm inner diameter reactor as shown in FIG. 5D), >90% PFOS destruction was achieved by three hours (see FIGS. 5A and 5B), with a first order rate of about 0.74 hr⁻¹ as shown in FIG. 5C. The slower treatment rate is expected but compensated for by the increased treatment volume (5.3 L), which results in an E_{Eo} of 35 kWh/m³ and a treatment flow rate of 1.75 L/hour. The decreasing treatment flow rate with the increase in treatment volume suggests that that the increase in volume treated is not enough to offset the lower energy consumption.

Furthermore, it is important to note that in each of the three distanced trials, the UV-activated chemistry in the system is an initial spike of 20 mM of sulfite and 10 mM of iodide as the two main photosensitizers, with additional spikes of 10 mM of sulfite every hour. These regular sulfite spikes are required to continue PFAS destruction and maintain a first order degradation rate over an extended duration. As can be seen in FIGS. 2A and 2B and FIGS. 3A, 3B, 3C, and 3D, PFAS degradation slows down at 2 hours and 3 hours respectively, suggesting the concentration of PFAS remaining (<1%) is lower than what can be readily destroyed in the system. However, FIG. 4C, shows that the first order degradation rate is linear across the full 6-hour duration, suggesting that at PFAS destruction rates less than 0.75 hr⁻¹, the hourly additions of sulfite are critical. This will also depend highly on the water chemistry of the system as well, as there are many other variables possibly present (e.g. dissolved oxygen, metals, carbonates, organic matter) that may require either higher initial concentrations of photosensitizer, or regular additions.

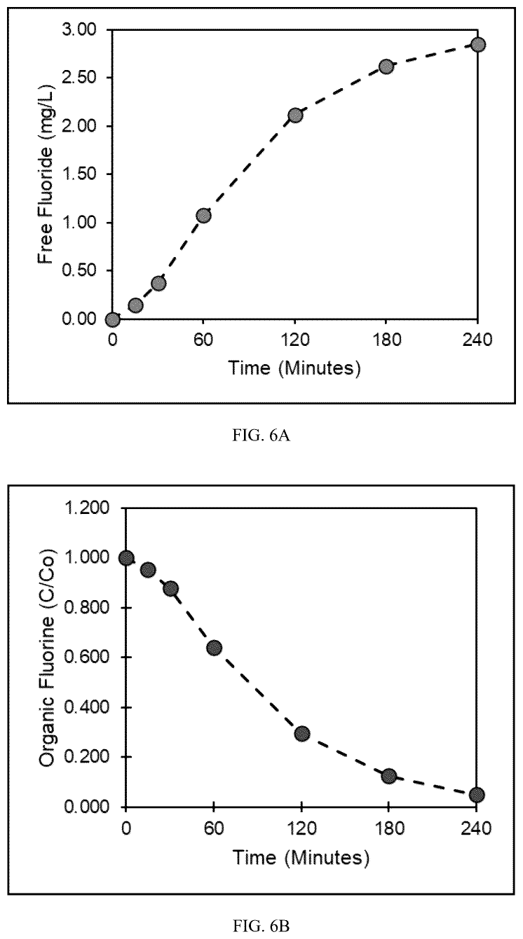

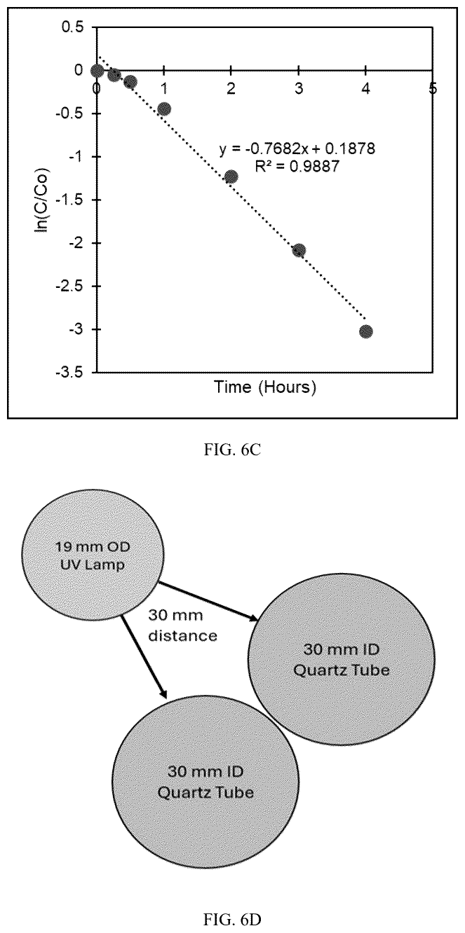

Results from the tube distance experiments identified the 30 mm distance as the most effective system to treat PFAS-impacted water, achieving a treatment rate of 1.85 L/hour, or a normalized treatment rate of 219 L/hour per m³ of reactor footprint. To this point, successful PFAS destruction was achieved at the 10 mm inner diameter reactor (using UV transmissible cuvettes) and at the 25 mm reactor diameter (using quartz tubing). These diameters align well with academic literature, which have identified an average effective optical path length of ˜29 mm, after which point UV light is significantly attenuated and PFAS destruction decreases. Work was performed to confirm and identify if PFAS destruction is significantly diminished with increased reactor diameters, beginning with a 30 mm diameter quartz tube reactor system positioned 30 mm from the UV lamp. The results of this study are shown in FIGS. 6A, 6B, and 6C, with FIG. 6D providing an illustrative depiction of the geographic orientation of the quartz tubing and UV lamp.

In this fourth reactor configuration (30 mm distance from lamp, 30 mm inner diameter reactor as shown in FIG. 6D), >90% PFOS destruction was achieved by four hours (see FIGS. 6A and 6B), with a first order rate of about 0.77 hr⁻¹ as shown in FIG. 6C, which is approximately half the rate at which PFOS was destroyed in the 25 mm ID reactor at the same distance as shown in FIG. 3A-3D. This indicates that the additional 5 mm of diameter does result in significant UV light attenuation, significantly reducing the overall system effectiveness. This reduced system effectiveness is not compensated for by an increase in treated volume, as the system has a calculated E_{Eo} of 48 kWh/m³ and a treatment volume of 1.11 L/hour, compared to the 1.85 L/hour in the 25 mm reactor system.

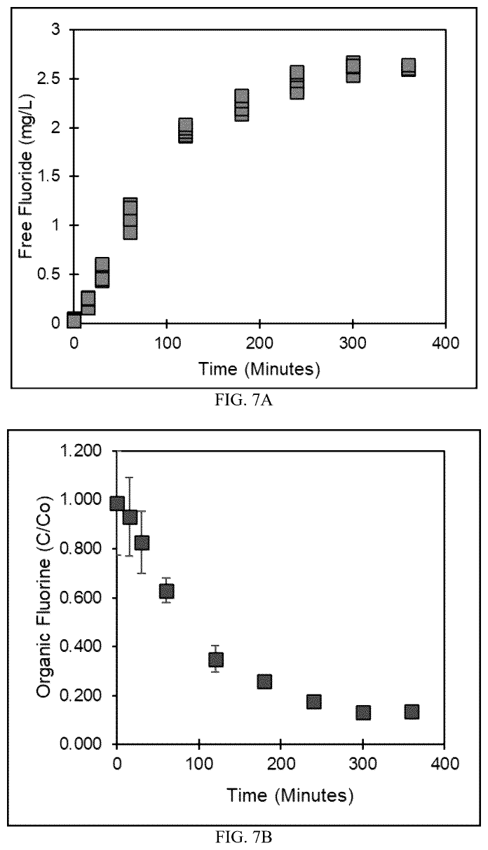

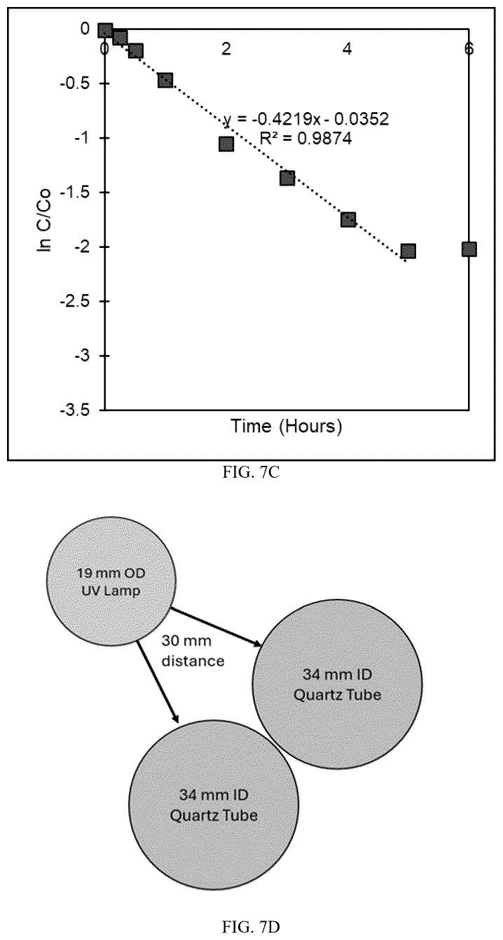

To provide a second point of confirmation, a fifth reactor configuration was investigated using 34 mm inner diameter quartz tubes, positioned at the same 30 mm distance from the UV lamp. The results are shown in FIGS. 7A, 7B, 7C, and 7D. In this fifth reactor configuration (30 mm distance from lamp, 34 mm ID reactor), only 87% PFAS destruction was achieved, representing the first trial in which >95% PFAS destruction was not achieved. Furthermore, the PFAS destruction rate was significantly slower than any previous reactor configurations, with a first order rate of about 0.42 hr⁻¹ as shown in FIG. 7C, which is approximately one fourth the rate at which PFOS was destroyed in the 25 mm ID reactor. This reinforces the conclusions identified in the 30 mm diameter reactor that increasing reactor diameter results in significant loss of system effectiveness without a corresponding increase in treatment volume to compensate. The calculated E_{Eo} for this system was found to be 54 kWh/m³, with a corresponding treatment volume of 0.98 L/hour.

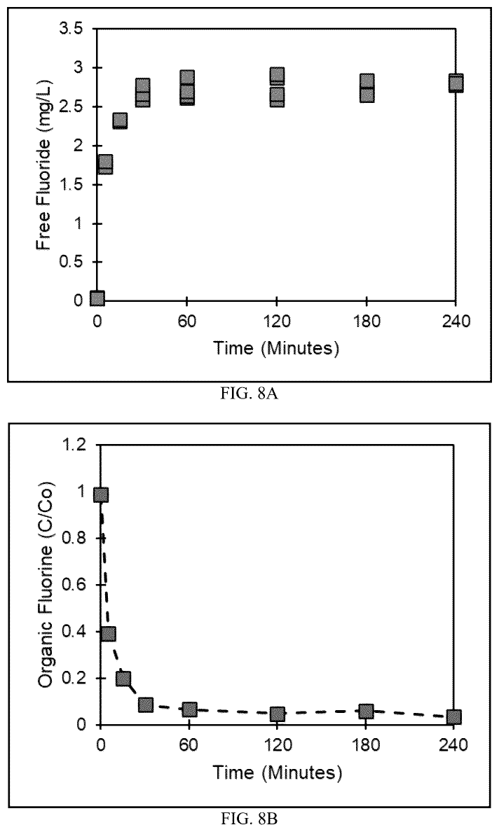

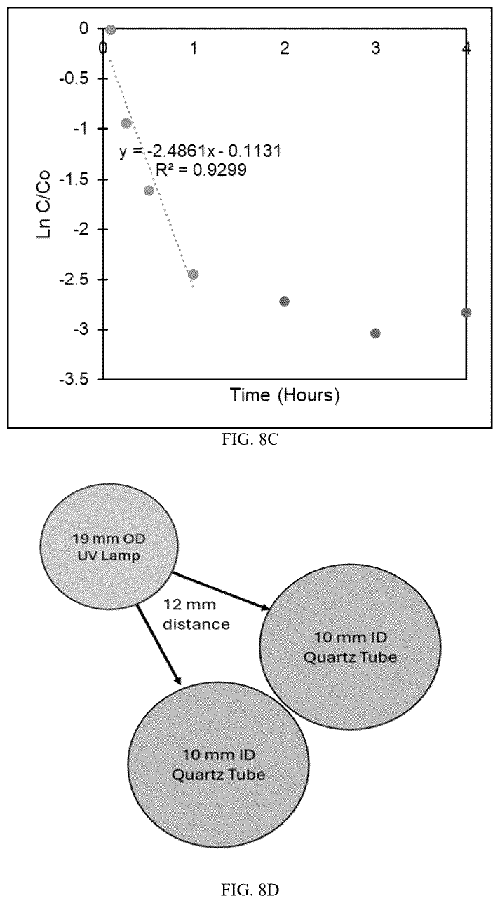

Initial investigations into reactor distance and diameter identified the upper optimal limit of reactor geometry to be 25 mm ID, spaced 30-50 mm away from the UV lamp. To identify the lower limit of the reactor geometry, the smallest possible configuration (10 mm ID, 12 mm distanced from the reactor) was investigated. The results of this study are shown in FIGS. 8A, 8B, 8C, and 8D. In this sixth reactor configuration (12 mm from UV lamp, 10 mm ID reactor as shown in FIG. 8D), >90% of PFOS is destroyed by 30 minutes (see FIGS. 8A and 8B), with a first order rate of about 2.49 hr⁻¹ as shown in FIG. 8C, significantly faster than the first order rate of 1.4 hr⁻¹ demonstrated by the 25 mm ID reactor positioned 30 mm from the UV lamp. However, this increased PFAS destruction time is offset by the significantly reduced treatment volume, with the system having a theoretical treatment volume of 0.55 L, compared to the 3.8 L of treated volume in the 25 mm ID, 30 mm distanced reactor. This reduced treatment volume results in an E_{Eo} of 113 kWh/m³, and a treatment rate of 1.11 L.

The conclusions of the reactor distance and diameter investigation identified several key operational parameters, including first order rate (k), the electrical consumption per order of magnitude destruction (E_{Eo}), the theoretical system volume (L), and the treatment rate (L/hour), which are summarized in Table 1.

TABLE 1
Operational parameters for the treatment reactors at three different
quartz tube distances and two different diameters. (*Most efficient
system, and **Fastest dimension-normalized system).

| | | | | | | |
|---|---|---|---|---|---|---|
| | First Order | | System | 90% Removal | Treatment | |
| | Rate (k) | E_{Eo} | Volume | Time | Rate | Norm. Treat. Rate |
| Variable | (hr − 1) | (kWh/m³) | (L) | (Hour) | (L/Hour) | (L/hour * m³) |

Fixed Inner Diameter (25 mm), Variable Distance from Lamp

| | | | | | | |
|---|---|---|---|---|---|---|
| *30 mm | 1.4 | 29 | 3.7 | 2 | 1.85 | 219 |
| 40 mm | 0.97 | 35 | 4.5 | 2.5 | 1.81 | 167 |
| 50 mm | 0.75 | 35 | 5.3 | 3 | 1.75 | 126 |

Fixed Distance from Lamp (30 mm), Variable Tube Diameter

| | | | | | | |
|---|---|---|---|---|---|---|
| *25 mm ID | 1.4 | 29 | 3.7 | 2 | 1.9 | 219 |
| 30 mm ID | 0.77 | 48 | 4.4 | 4 | 1.11 | 117 |
| 34 mm ID | 0.42 | 54 | 4.9 | 6 | 0.98 | 90 |

12 mm Distance from Lamp, 10 mm Inner Diameter

| | | | | | | |
|---|---|---|---|---|---|---|
| **10 mm ID | 2.49 | 113 | 0.55 | 0.5 | 1.11 | 539 |

At first appearance, overall system effectiveness increases with increasing reactor distance from the lamp, which is a result of the treated system volume increasing faster than the reduction in treatment speed. However, it is important to consider the overall space requirement of the reactor, especially when considering the need to stack multiple reactors together to increase total treatment rates. Assuming each reactor packed into a perfect hexagon jacket and stacked into a cubic meter of space, the overall normalized treatment rate decreases with increasing tube distance, with the 30 mm distanced reactor achieving a treatment rate of 219 L/hour*m³, and the 50 mm distanced reactor achieving only 126 L/hour*m³.

When considering the effective reactor (tube) diameters for the systems, it can be seen that between 10 mm and 25 mm (UV quartz reactor) is the ideal range at which PFAS destruction is effective. Increasing the tube diameter to 30 mm ID and 34 mm ID resulted in half and one quarter the rate of PFAS destruction when compared to the 25 mm ID system, without a subsequent compensatory increase in treatment volumes.

Transmissivity is another feature of the present invention. In one embodiment quartz is selected as a material to yield optimum transmissivity of UV light. The configuration of the tubes within the reactor is selected to be energy efficiency and for providing maximum efficacy of PFAS destruction. While other materials are contemplated and within the scope of the present invention, quartz appears to be the optimum material for a confluence of transmissivity, configuration, and strength.

According to one embodiment of the present invention the upper limit is 25 mm ID reactor distanced 30-50 mm away of the system effectiveness. When considering the results of the 10 mm ID reactor distanced 12 mm away, the individual reactor is the most inefficient of the six reactor designs, with a significantly higher electrical consumption (113 kWh/m³), and a lower treatment rate (1.11 L/hour). However, the compact nature of the reactor allows for more reactors to be constructed and operated within a given space, resulting in a normalized treatment rate of 539 L/hour*m³. This scaled up system involves a significant number of individual reactors (>100 reactors/m³ of space) and uses a significant electrical infrastructure to sustain. Nevertheless, it represents the ‘fastest’ treatment system that serves as a strong foundation with which to drive optimization.

The analysis continues using a two-tube reactor set-up, in which the PFAS destruction rates are determined, and the results are extrapolated to identify the effectiveness of the fully constructed system. Prior analysis identified the most efficient reactor to destroy PFAS (25 mm ID reactor tubes positioned 30 mm away from the UV lamp) and the faster reactor to destroy PFAS (10 mm ID reactors positioned 12 mm away from the UV lamp). Following this work and according to one embodiment of the present invention, a 10 mm ID Tubulator system was used to validate the theoretical model as well as provide a foundation for a true flow-through treatment system capable of destroying PFAS. Accordingly, a 2-tube vertical reactor system was scaled to a 12-tube, horizontal reactor. FIGS. 9A, 9B, and 9C show the structure of this 10 mm ID Tubulator System 100.

Turning to FIGS. 9A, 9B, and 9C one embodiment of the present invention, is shown of a 12-reactor treatment system, with 10 mm ID quartz tubes 300 situated in series around a central UV lamp 600, with the quartz tubes 300 positioned 12 mm away from the UV lamp 600. This system has an active (UV-irradiated) volume of 400 mL, with a total volume (including U-bends 200) of ˜450 mL. Based on the required residence time to achieve>90% PFAS destruction (30 minutes), it was determined that a maximum flow rate of 15 mL/minute would be needed, equating to a single system treatment rate of 0.9 L/hour. The first design task would be acquiring or designing the appropriate U-bends 200 for the systems. Further shown in FIGS. 9A, 9B, and 9C include inlet 400 and outlet 500 tubing to pump the contaminated sample through the reactor system 100.

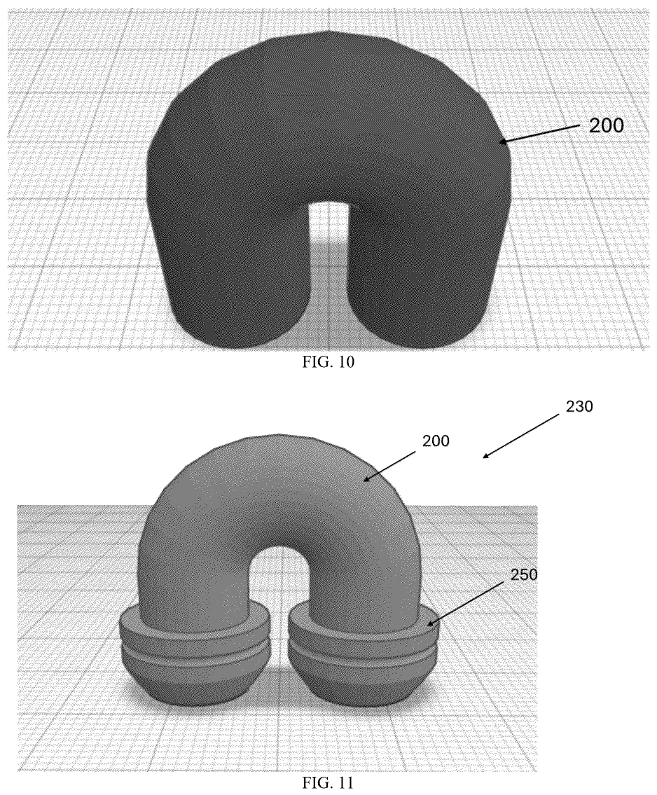

Initial trials were performed with PVC tubing, but the tubing would crimp when bent at the angle required to situate the quartz tubes 300 close to each other. The solution to this was to employ custom quartz U-bends 200 that would have the fittings and dimensions appropriate for the quartz reactor tubes 300. According to one embodiment of the present invention, 3D printed U-bends 200 using polyethylene terephthalate glycol (PETG) were used to connect the 3D printed U-bends 200 to the quartz tubes 300 with PVC tubing. The first design was a simple U-bend 200 to get the right fit as shown in FIG. 10. The U-bend 200 of FIG. 10 was designed to have 14 mm OD, 10 mm ID, 4 mm spacing.

The initial U-bend 200 was designed to sit flush with the end of the quartz tube 300, with the two pieces joined using flexible PVC tubing (not shown). The quartz tube 300 (12 mm OD×10 mm ID) would be smaller, but more rigid than the U-bend 200 (14 mm OD×10 mm ID). The PVC tubing (14 mm OD×12 mm ID, flexible) was found to easily fit onto the quartz tubing 300 and could be made to fit onto the 3D U-bend 200 with the application of heat. Imperfections in the 3D print process resulted in small grooves in between the 3D printed U-bend and the PVC tubing, causing considerable leaking. Therefore, the second prototype 230 was made wider 240, with a barbed fitting, and an inner recessed ring 250 to fit an O-ring. See FIG. 11 showing a barbed fitting U-bend 230, with 14 mm OD, 10 mm ID, and 12 mm OD recessed ring 250.

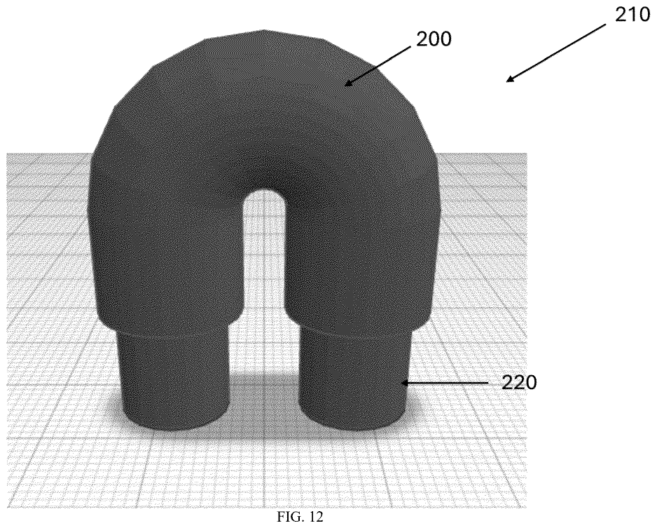

The barbed fitting U-bend 230 was found to result in less leaking than the simple U-bend 200, as the O-ring provided a better contact surface, and the barb 250 nested into the inner diameter of the quartz tubing 300 slightly. However, leaking did still occur, likely due to the O-ring 250 sitting imperfectly. It was hypothesized that leaking could be further reduced by having the U-bend fit inside of the quartz tubing, and then having the PVC tubing connect it, with an epoxy or adhesive to improve the PVC tubing U-bend connection. Turning to FIG. 12 demonstrates this alternative embodiment of the U-bend 210 comprising the U-bend 200 coupled to insert pieces 220 that is configured to sit inside the quarts tubing 300. The embodied U-bend 210 was formed having dimensions: 13 mm OD, 8 mm ID, 4 mm gap, 180-degree bend angle. The third U-bend 210 design was found to further reduce leaking, as the increased surface area of the both the inserts 220 and the PVC tubing connector 200 inhibited water transport out of the tubing. Any additional leaking was stopped through the addition of a sealant, such as super glue, to the outside of the U-bend 210, which adhered to the PVC tubing and formed a leak-resistant seal.

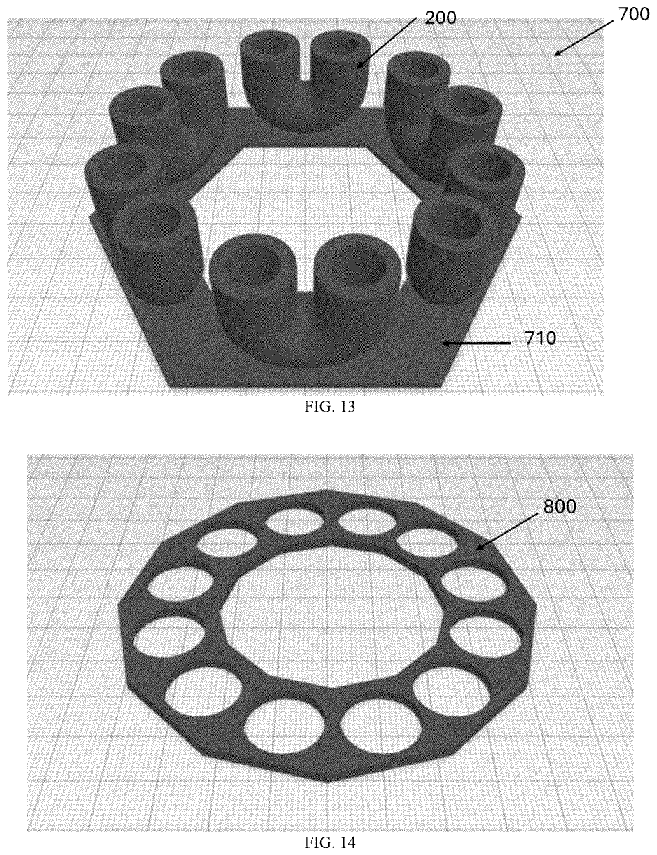

The end goal for the Tubulator 100 design was to be positioned equidistant around a UV lamp 600. According to one embodiment of the present invention, a system to hold each of the 12 quartz tubes 300 in place without applying mechanical stress on the U-bends 200 or the fragile glass tubes 300 themselves was designed. A 3D printed mount 700 was designed that would hold the tubes 300 in a fixed position while also allowing the UV lamp 600 to be inserted in the middle, and allow for pump tubing (400,500) to be connected. The first design connected the U-bends 200 to a 3D printed hexagon baseplate 710, as shown in FIG. 13.

A first mount prototype was developed with the simple U-bends 200 to simply identify if the shape and positioning would be correct. Attaching the quartz tubes 300 to the first baseplate 710 was found to be quite simple and held the tubes 300 loosely in the correct position. However, attaching the second baseplate (to the other end of the quartz tubes 300) resulted in significant challenges, as each U-bend 200 had to be attached individually, which was made impossible by the rigidity of the baseplate 710. As soon as half the U-bends 200 were attached, the other U-bends 200 were at too steep of an angle to position, resulting in damage to one of the quartz tubes. Therefore, it was determined that the mount 700 itself would need to be kept separate from the U-bends 200. To this end, a series of guiding collars 800 were designed as shown in FIG. 14. The exemplified guide collar 800 in FIG. 800 was designed with dimensions: diameter: 90 mm. Inner diameter: 50 mm. Inner diameter of quartz tube mounts: 16 mm.

The guide collars 800 were found to perfectly align the reactor tubes 300 in place, while having enough flexibility to allow the tubes 300 to shift in response to the U-bends 200 and pump tubing (400,500) being mounted. It was determined that three collars 800 provided ample support for the shape of the Tubulator reactor 100, with one on each end and one in the middle during storage, and the middle one shifted to one end during active use.

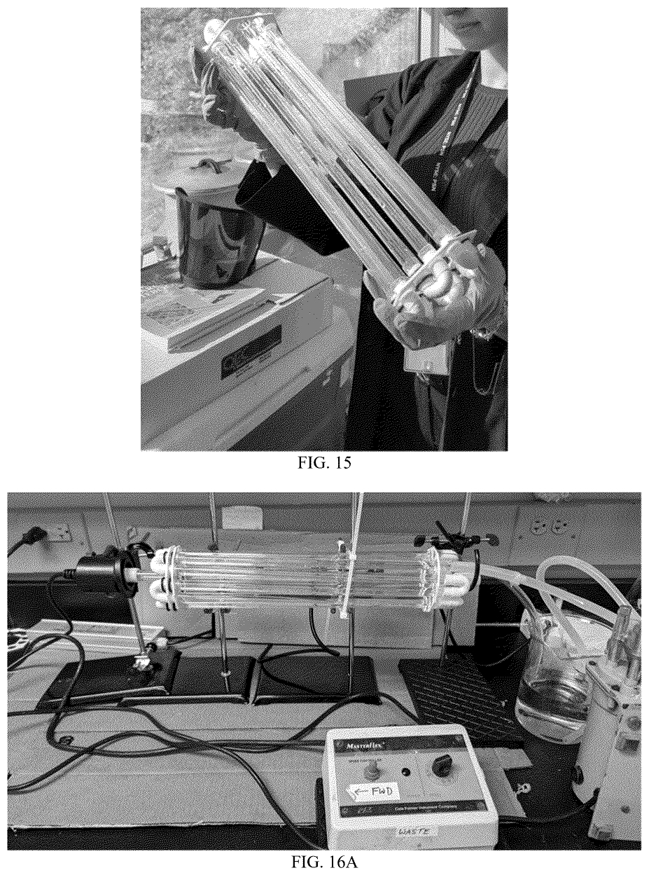

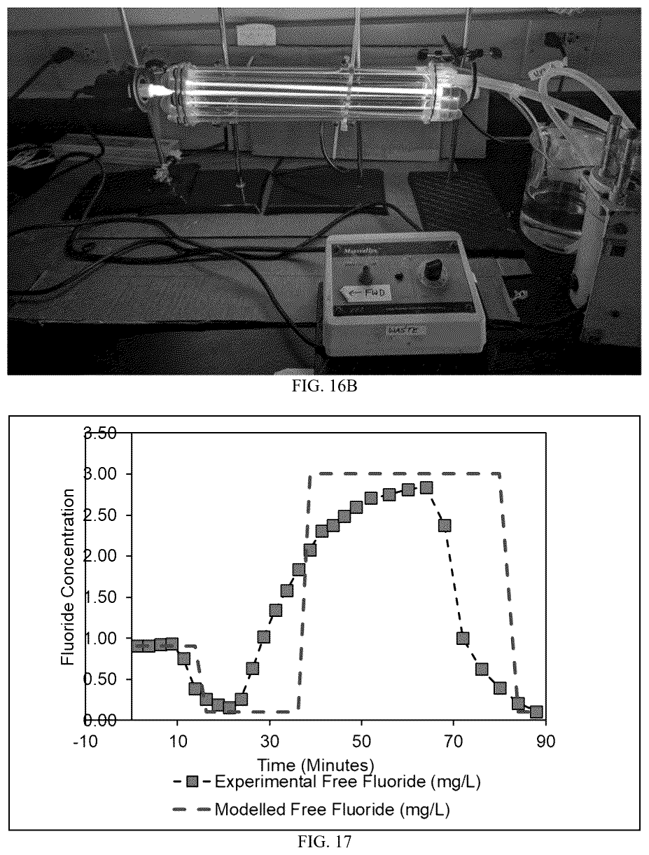

The initial model for the Tubulator system 100 involved 12 quartz tubes 300, each with 10 mm IDs, positioned around a UV lamp 600 at a 12 mm distance. However, this initial design assumed perfect positioning of the quartz tubes 300, with each tube touching its neighboring tubes and no UV light escaping. The U-bend 200 design resulted in additional ‘diameter’ added to each of the quartz tubes due to the thickness of the PVC tubing (˜2 mm diameter), resulting in an ˜4 mm gap between each of the quartz tubes 300. This required the quartz tubes 300 to be positioned 15 mm away from the UV lamp 600 instead of 12 mm, to compensate for the altered dimensions. Following its construction (see FIG. 15), the 10 mm ID Tubulator 100 was mounted with clamps and flushed with tap water to clear out any air bubbles and debris. Photographs of the Tubulator 100 mounted horizontally are shown in FIG. 16A and turned on and operational is shown in FIG. 16B.

In one embodiment, the 450 mL Tubulator (having ˜500 mL with pump tubing) was assessed by prefilling the reactor with 500 mL of tap water (˜0.9 mg/L inorganic fluoride), and then flushed with 300 mL of DI water mixed with photosensitive chemicals (20 mM Na₂SO₃, 10 mM KI, 10 mM NaHCO₃, 150 mM NaOH). This was done to prime the system and purge any bulk oxygen (bubbles) or dissolved oxygen (activation of Na₂SO₃). At this stage, the UV lamp was turned on, and 400 mL of PFOS (3.0 mg/L organic fluorine of the PFOS stock solution 2) mixed with the appropriate reduction chemicals (20 mM Na₂SO₃, 10 mM KI, 10 mM NaHCO₃, 150 mM NaOH) was flowed through the Tubulator at a rate of 13 mL/minute. Following the completion of PFOS pumping, the system was flushed with 100 mL of PFOS-free reduction solution. As soon as the PFOS solution started pumping, effluent samples were collected every 2.5 minutes in ˜32 mL bins for 50 minutes, and then ˜50 mL bins were collected every 4 minutes for an additional 40 minutes (90 minutes total). The actual measured free fluoride, and modelled (expected) free fluoride, can be seen in FIG. 17.

Based on the contents of the initial system (200 mL of tap water, ˜0.9 mg/L inorganic fluorine, 300 mL of PFAS free reaction solution, ˜0.1 mg/L inorganic fluorine, 400 mL of PFOS containing reaction solution, ˜3.0 mg/L organic fluorine) and the flow rate of the system (13 mL/minute) the modelled (expected) free fluoride can be modelled as a function of experimental time. Based on this, it was expected that inorganic fluoride from the tap water would be flushed out by 16 minutes, and the first increase of inorganic fluoride from the destruction of PFOS wouldn't be sampled until ˜39 minutes, with a maximum fluoride concentration of 3.0 mg/L. As shown in FIG. 17, the initial flush of fluoride occurred earlier than expected, with residual fluoride remaining in the system ˜5 minutes longer than expected. Almost immediately after the tap water was flushed from the system, inorganic fluoride from the destruction of PFOS was released in the effluent, 10 minutes earlier than expected. This trend of increasing fluoride concentration continued until it reached a peak of 2.84 mg/L fluoride (95% destruction) at the 64-minute mark, before drastically diminishing over the next 26 minutes.

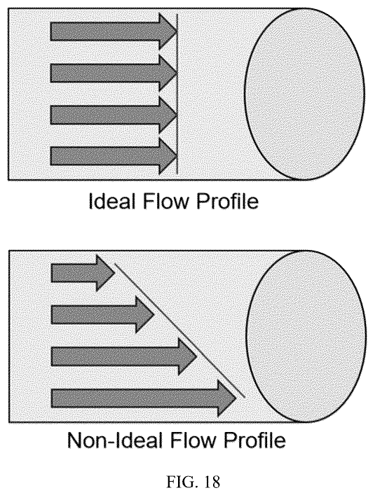

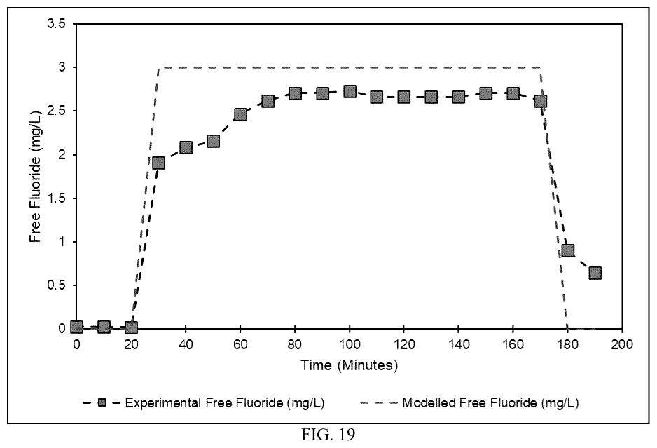

In one embodiment of the present invention (plug flow regime), the solution is pumped at a steady rate with a consistent front surface area, achieving laminar flow with no in-tube mixing. The results shown in FIG. 17 suggest that the first evaluation of the Tubulator system had significant issues with a heterogeneous flow profile, resulting in the PFAS solution being ‘pushed’ through the system faster than the 13 mL/minute flow rate. See FIG. 18 which illustrates an ideal flow profile compared to a non-ideal flow profile.

Without being limited by theory, it is suspected that the non-ideal flow profile as shown by the data is being caused by the low flow rate, the difference in inner diameters between the pump head (4 mm ID) and the quartz tubing (10 mm ID), and the potential mixing areas/dead zones caused by the U-bends. To address this, the analysis was repeated using a larger ID pump tubing (8 mm ID), and the PFAS solution was pumped for a longer duration, with no tap water in the system initially. See FIG. 19, which shows the measured free fluoride compared to the modeled free fluoride. The larger inner diameter of the pump tubing allowed for an increased pump rate of 15 mL/minute.

As shown in FIG. 19, the increase in the inner diameter of the pump tubing dramatically improved the plug flow profile of the system, with the time points of expected fluoride increase (30 minutes) and decrease (180 minutes) matching up well with the experimental data. Furthermore, the initial system conditions of this trial were simplified, with the system being purged completely with deionized water before operation, and no PFOS-free reagent solution was used to prime the system. This lack of PFOS-free reagent solution purging would result in dissolved oxygen remaining in the system initially, which explains the lag in PFAS destruction between 30 and 80 minutes. From 80 to 170 minutes the system reaches peak PFOS destruction of 91%, treating approximately 2 L of PFOS-containing water in 2.5 hours. This equates to an experimental treatment flow rate of 0.8 L/hour, which is a 28% deviation from the theoretical treatment flow rate of 1.11 L/hour determined in Table 1. The deviation from the theoretical treatment rate is due to UV ‘dead’ zones (e.g. U-bends) which did not receive UV light, and gaps between the quartz tubes in the full photoreactor system. Both of these scenarios result in the UV light being underutilized, and therefore resulting in a decreased reaction rate in the experimental system.

Several key system parameters are necessary to achieve effective destruction of PFAS in a flow through treatment mode using the UV-activated sulfite and iodide photochemical system and are discussed below in Table 2.

TABLE 2
Identified problems and solutions for several issues
or roadblocks identified across the project.

| | |
|---|---|
| Problem | Solution |

Technical Issues

| | |
|---|---|
| Incorrect items were shipped | Correct parts, implemented improved inventory |
| and not identified until after | check procedures |
| failed experiments (e.g. | |
| cuvettes) | |
| Shared laboratory equipment | Equipment was repaired where possible and |
| was found to be poorly | proper maintenance protocols were updated. |
| maintained, or contaminated, | Otherwise, new equipment was purchased and |
| which impacted project | restricted for use only on this project |
| success | |
| Shared laboratory space was | Unused equipment was cleaned and moved to |
| found to be insufficient, or | storage to free up more space. Space was |
| contaminated, which | decontaminated aggressively and improving |
| impacted project success | cleaning protocols have been discussed with team. |

Chemical/Engineering Issues

| | |
|---|---|
| Systems suffered from | System was modified from a two-pump to one- |
| leak/pressure issues during | pump system to reduce pressure issues, and |
| initial development | different adhesives/epoxies were investigated to |
| | improve part seals |
| Glass components (e.g. quartz | Non-glass components were redesigned to reduce |
| tubing) underwent chipping, | physical stress on the glass components, reducing |
| cracking, breaking due to | mechanical failure. Where possible, damaged |
| regular use | glassware was repurposed. |
| Salt was found to deposit in | Quartz tubing diameter was reduced, which |
| the quartz tubes during/after | allowed for increased flow rate and the thorough |
| treatment runs | flushing of reagents to prevent deposition |
| Bulk air (bubbles) and | As above, quartz tubing diameter was reduced, |
| dissolved oxygen were found | which increased flow rate and allowed for |
| to significantly inhibit PFAS | thorough flushing of air bubbles. Dissolved |
| destruction due to oxygen | oxygen was removed through flushing with |
| interfering with the aqueous | PFAS-free photosensitizer solution. |
| electron chemistry | |

The issues identified throughout the work can be broadly categorized as technical issues (issues outside of the project, but still impacting the project) and chemical/engineering issues (issues within the focus on investigation itself). The three technical issues faced at the start of the project (incorrect items, equipment/space issues) are common issues that were corrected through discussions and updated protocols.

The four main chemical/engineering issues (leaks, breaks, salting, air) are issues that were identified during system scale up as the system is transitioned from a batch reactor to a continuous flow-through reactor. Each solution implemented to these issues was effective.

According to one embodiment of the present invention, a range of effective values for quartz tube reactor diameter (10 mm-25 mm) and reactor distance from the UV lamp (10 mm-30 mm) has been identified. These values have culminated in two distinct reactor configurations: the 25 mm ID reactors spaced 30 mm away from the UV lamp, and the 10 mm ID reactors spaced 12 mm away from the UV lamp. The larger reactor system has an E_{Eo} of 29 kWh/m³, a treatment rate of 1.85 L/hour, and a normalized treatment rate of 219 L/hour per m³ of reactor space. The smaller reactor system itself is less efficient and slower, with an E_{Eo} of 113 kWh/m³ and a treatment rate of 1.11 L/hour, but its reduced size allows more systems to be combined in a given space, giving it a superior normalized treatment rate of 539 L/hour per m³ of reactor space.

The smaller ‘Tubulator’ system was fully constructed and evaluated, with the system's treatment rate (0.8 L/hour) deviated less than 30% from the theoretical treatment rate (1.11 L/hour). The major discrepancy between the experimental system and it's theoretical model is the difference in the normalized treatment rate. This is due to the larger system diameter in the experimental Tubulator system, which itself was caused by the 3D printed collars, U-bends, and PVC tube connectors as described in Table 3.

TABLE 3
The two main theoretical ‘Tubulator’ systems compared to the first experimental
‘Tubulator’ system created at the end of this project.

| | | | | | | |
|---|---|---|---|---|---|---|
| | First Order | | System | 90% | Treatment | Norm. Treat. |
| | Rate (k) | EEo | Volume | Removal | Rate | Rate (L/hour * |
| Reactor | (hr − 1) | (kWh/m3) | (L) | Time (Hour) | (L/Hour) | m3) |

Theoretical System Based on Two-Tube System

| | | | | | | |
|---|---|---|---|---|---|---|
| 25 mm ID, | 1.40 | 29 | 3.7 | 2.00 | 1.9 | 219 |
| 30 mm Dis | | | | | | |
| 10 mm ID | 2.49 | 113 | 0.55 | 0.5 | 1.11 | 539 |
| 12 mm Dis | | | | | | |

Experimental ‘Tubulator’ System

| | | | | | | |
|---|---|---|---|---|---|---|
| 10 mm ID, | N/A | N/A | 0.45 | N/A | 0.8 | 210 |
| 15 mm Dis | | | | | | |

In another version of the present invention additional reactor geometries are utilized (e.g. 10 mm ID, 30 mm distanced), and multiple reactors operating together are employed. A multi-Tubulator treatment system capable of achieving treatment rates of 20-40 L/hour is within the scope of the present invention and is indeed contemplated.

In yet another version of the present invention the destruction or removal of co-contaminants such as dissolved metals, dissolved organic matter, or other novel emerging contaminants like 1,4-dioxane is employed. This approach improves the robustness of the system for destroying PFAS in more complex matrices, while also extending the applicability of the technology to handle other contaminated sites.

Embodiments of the present invention and many of its improvements have been described with a degree of particularity. It should be understood that this description has been made by way of example, and that the invention is defined by the scope of the following claims.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

The innovation described herein is an engineered system designed to destroy PFAS in water using UV-activated synergistic chemical reactions. The present invention uses UV-light to activate photosensitizers (chemicals which react when exposed to UV light) which generate several different reactive radical species. These reactive radical species react with a broad range of PFAS and breaking the associated C—F, C—C, C—S, and C—H bonds that make up these molecules. This process results in the destructive conversion of PFAS to free fluoride and other innocuous byproducts. The underlying chemistry of this innovation is unique in its ability to tailor the reactive chemical species specific to the PFAS and aqueous matrix under remediation. For aqueous matrices containing high concentrations of organic matter, or fluorotelomer PFAS, the initial chemical environment can be tailored to deliver high yields of oxidizing radicals, through the use of hydrogen peroxide, persulfate (sodium, potassium), sulfite (sodium or potassium) with sparged air, or reactive oxygen generating metal nanomaterials like titanium oxide, zinc oxide, and silver.

For aqueous matrices containing PFAS and high concentrations of dissolved inorganic metals (e.g. iron), the initial chemical environment can be shifted to a highly alkaline environment (hydroxide, sodium or potassium) and mixed thoroughly to precipitate out metals through their reaction with hydroxide. For aqueous matrices containing high concentrations of PFAS and/or molecules like nitrites/nitrates, or halides, the initial chemical environment can be tailored to deliver high yields of reducing radicals, using sulfite, iodide, (bi) carbonate, in a high pH (>13) environment. These three main chemical operation methods (oxidation, metal precipitation, reduction) allow this system to destroy PFAS under a broad range of conditions to a high degree (>99.9%) of removal.

The innovation described in this work operates in a ‘flow-through’, or ‘continuous flow’ operation mode, in which PFAS-impacted waters are continuously amended with reagents and pumped through the treatment system with no interruptions to flow rate or treatment volume. This flow-through design allows for the system to be applied as a stand-alone PFAS treatment technology, as well as allowing it to be incorporated as part of a comprehensive treatment train in tandem with technologies such as foam fractionation, sedimentation, flocculation, and adsorption-clean up. This flow through mode is supported by on-line monitoring instruments that allow for continuous monitoring of key water parameters, which can be modified as needed to maintain the optimal conditions for PFAS degradation.

While there have been described above the principles of the present invention in conjunction with a system for continuous PFAS destruction, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom

In the above description, certain relative terms may be used such as “up,” “down,” “upper,” “lower,” “horizontal,” “vertical,” “left,” “right,” “proximal,” “distal,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In some instances, the benefit of simplicity may provide operational and economic benefits and exclusion of certain elements described herein is contemplated as within the scope of the invention herein by the inventors to achieve such benefits. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for continuous PFAS destruction, comprising: a multi-quartz tube assembly configured for arranging around a UV lamp; a reagent introduction mechanism for delivering a photosensitizer mixture into the multi-quartz tube assembly; a gas introduction mechanism for delivering atmospheric air into the multi-tube quartz assembly; and a flow control mechanism for regulating the flow of an aqueous PFAS-containing solution through the multi-quartz tube assembly.

2. The system of claim 1, wherein the photosensitizer mixture comprises a sulfite salt, an iodide salt, and a carbonate salt in an alkaline solution.

3. The system of claim 1, further comprising an air introduction system configured to introduce oxygen into the aqueous solution to modify the oxidative-reductive potential.

4. The system of claim 1, wherein the multi-quartz tube assembly comprises tubes having an inner diameter selected from the group consisting of 10 mm, 25 mm, 30 mm, and 34 mm.

5. The system of claim 4, wherein the tubes are positioned at a distance from the UV lamp selected from 12 mm, 15 mm, 30 mm, 40 mm, and 50 mm.

6. The system of claim 1, further comprising a monitoring unit configured for continuous monitoring of key water chemistry parameters.

7. A method for PFAS destruction, comprising: mixing a PFAS-containing solution with a photosensitizer mixture; irradiating the mixture with ultraviolet light in a tubular system; and continuously flowing the mixture through the system to achieve PFAS destruction.

8. The method of claim 7, wherein the photosensitizer mixture generates aqueous electrons to initiate PFAS destruction.

9. The method of claim 7, wherein the ultraviolet light has a wavelength range from about 185 nm to 254 nm.

10. The method of claim 7, further comprising adjusting the oxidative-reductive potential of the system through the addition of oxygen or sulfite.

11. The method of claim 7, further comprising using a modular reactor design to optimize treatment for varying aqueous matrices.

12. The method of claim 7, wherein the destruction rate of PFAS exceeds 90% within one hour.

13. The method of claim 7, wherein the photosensitizer mixture includes sodium sulfite and potassium iodide.

14. A reactor for PFAS treatment, comprising: a central UV light source; a plurality of quartz tubes configured circumferentially around the UV light source; a reagent supply system; and an inlet and outlet system for maintaining continuous flow.

15. The reactor of claim 14, wherein the quartz tubes have an adjustable spacing relative to the UV light source.

16. The reactor of claim 14, further comprising a guide collar for maintaining positional stability of the quartz tubes.

17. A UV-activated chemical treatment apparatus, comprising: a housing for containing a UV light source; a circulation system for aqueous solutions; and a reagent delivery system for introducing sulfite-based photosensitizers.

18. The apparatus of claim 17, wherein the circulation system comprises quartz tubes that provide high UV transmissivity.

19. The apparatus of claim 17, wherein the reagent delivery system facilitates controlled dosing of photosensitizers.

20. The apparatus of claim 17, further comprising a data acquisition system for tracking operational parameters during treatment.
